(19) United States
(12) Patent Application Publication
(10) Pub. No.: US 2007/0078751 A1
(43) Pub. Date: Apr. 5, 2007

(54) System and method for providing secure financial transactions for open network commerce

(76) Inventor: James Craig, Toronto (CA)

Correspondence Address: EDWARDS & ANGELL, LLP, P.O. BOX 55874, BOSTON, MA, 02205, US

(21) Appl. No.: 11/242,448

(22) Filed: Oct. 3, 2005

(51) Int. Cl. G06Q 40/00

(52) U.S. Cl. 705/37; 705/44

(57) ABSTRACT

A system for conducting commerce across a distributed network includes a remote consumer computer. A merchant server communicates with the remote consumer computer across an open network to enable purchasing of a product from the remote consumer computer. A financial clearing house server is located within a secured closed network and communicates with the remote consumer computer and the merchant server across the secured closed network. The merchant server creates a merchant ID, receipt ID and transaction total corresponding to a consumer transaction and sends the merchant ID, receipt ID, and transaction ID to the financial clearing house server and the remote consumer computer. The financial clearing house server arranges payment of the transaction in response to a matching merchant ID, receipt ID, and transaction total from the remote consumer computer.

### BACKGROUND OF THE INVENTION

This invention is directed to a method for securely conducting a commercial transaction, and more particularly, for securely conducting a commercial transaction over a distributed network such as the World Wide Web.

With the e-commerce explosion have come a plethora of new issues, primarily the balancing of a purchaser's security and privacy. In conventional commerce, those requiring face-to-face transactions, such as at retail stores, restaurants, gas stations or the like, all that is required to purchase a product is the exchange of cash. The consumer need not be identified to the vendor. There is no need to exchange addresses, shipping information or even method of purchase to anyone other than the vendor.

Even with credit card purchases, pursuant to face-to-face transactions, the name and the credit card number of the consumer may be exchanged, but not the address or other billing information. The distributed network nature of e-commerce has changed all of this.

What is typical of an e-commerce network is that a merchant will conduct business with a consumer without face-to-face interaction. The process is automated and distant. The merchant, as viewed from the web, may in fact not be the ultimate fulfillment entity and will almost never be the financial transaction entity. As a result, as is known in the art, the consumer is often required to provide shipping information, billing addresses, financial information and the like so that the merchant may interact with the fulfillment and financial entities providing those functions of the e-commerce transaction.

Reference is now made to FIG. 1 in which a current model for open network e-commerce is provided. As seen, a system 10 includes remote consumer computers 20 accessing a merchant network presence, in the form of a server 30. Consumer computers 20 may access merchant network server 30 through an open network 40 accessible by conventionally known means such as a mobile network 50 or a TDM network 60. Merchants may also communicate with server 30 via remote computers 70 across TDM network 60 and mobile network 50 to respective customers. A financial transaction clearing house may have a presence on open network 40 utilizing a financial transaction server 80. Financial institutions 80 recognize the importance of the data with which they are entrusted and normally are located on their own secure network 100. A third-party manufacturer or supplier has a presence at a server 110 and communicates over open network 40.

During use, a consumer utilizing a computer from a remote network 50, 60 accesses merchant information at merchant server 30. If the process is automated, server 30 will receive shipping information and billing information from consumer 20 and provide the appropriate information across open network 40 to manufacturer for fulfillment and to financial transaction server 90 for payment. Server 90 will then utilize the information provided by merchant server 30, forward the information to its secure financial network 100, process the information and cause payment to be made to the merchant at its computer 70 utilizing server 30.

As can be seen, financial institution servers 120 are isolated from open network 40.

This prior art method of doing business has been satisfactory. However, it suffers from several disadvantages. First, the World Wide Web is an open distributed network. As a result, there are multiple points along the transaction at which the privacy or security of the consumer may be jeopardized. In other words, there is ample opportunity for misuse and misappropriation of the private information submitted by the consumer to the merchant.

Congress has tried to legislate a remedy for this issue by requiring privacy policies for e-commerce merchants. However, nothing in the privacy policy prohibits any merchant from reselling a consumer's private information unless specifically instructed not to by the consumer. Often, by means of “Opt Out,” “Opt In” or “Click Through” requirements, merchants make it particularly difficult for consumers to prohibit the resale or redistribution of their personal information.

Furthermore, as a result of providing all of the sensitive information to the merchant, the sensitive information is often stored at open network access points such as on the hard drive of the consumer or on the server of the merchant. In the case of the hard drive, spyware is often used, or unscrupulous merchants make use of cookies for their own commercial advantage. Likewise, maintenance of confidential and sensitive information on a merchant's server could make it susceptible to hacking if the merchant does not take affirmative steps to protect the information. Many online merchants are incapable of offering such protection for either commercial or technological reasons.

It has been known in the art to address the security concern by merchants making use of secure servers, which are difficult though not impossible to access. For information utilized on a network-wide basis, merchants often use encryption technology such as a secure sockets layer (SSL) technology, which encrypts the information during any data exchange session.

To protect the privacy concern, third party billing entities such as PayPal and BillMeLater are known in which sensitive information is stored at the third party billing entity. However, other than an impetus to maintain tighter security than the merchant's, it is tantamount to maintaining the financial information at the merchant's website. However, it does remove the repeated need to transfer financial information to a merchant.

Accordingly, a system and method which overcome the shortcomings of the prior art are desired.

### BRIEF SUMMARY OF THE INVENTION

A system for conducting commerce across a distributed network includes a remote consumer computer. A merchant server communicates with the remote consumer computer across an open network to enable purchasing of a product from the remote consumer computer. A financial clearing house server is located within a secured closed network and communicates with the remote consumer computer and the merchant server across the secured closed network. The merchant server creates a merchant ID, receipt ID and transaction total corresponding to a consumer transaction and sends the merchant ID, receipt ID, and transaction ID to the remote consumer computer. The financial clearing house server arranges payment of the transaction in response to a matching merchant ID, receipt ID, and transaction total from the remote consumer computer.

### BRIEF DESCRIPTION OF THE DRAWINGS

A more complete understanding of the present invention can be more readily understood by reference to the following detailed description when considered in conjunction in connection with the accompanying drawings, wherein:

FIG. 1 is a schematic drawing of an open network e-commerce system constructed as known from the prior art;

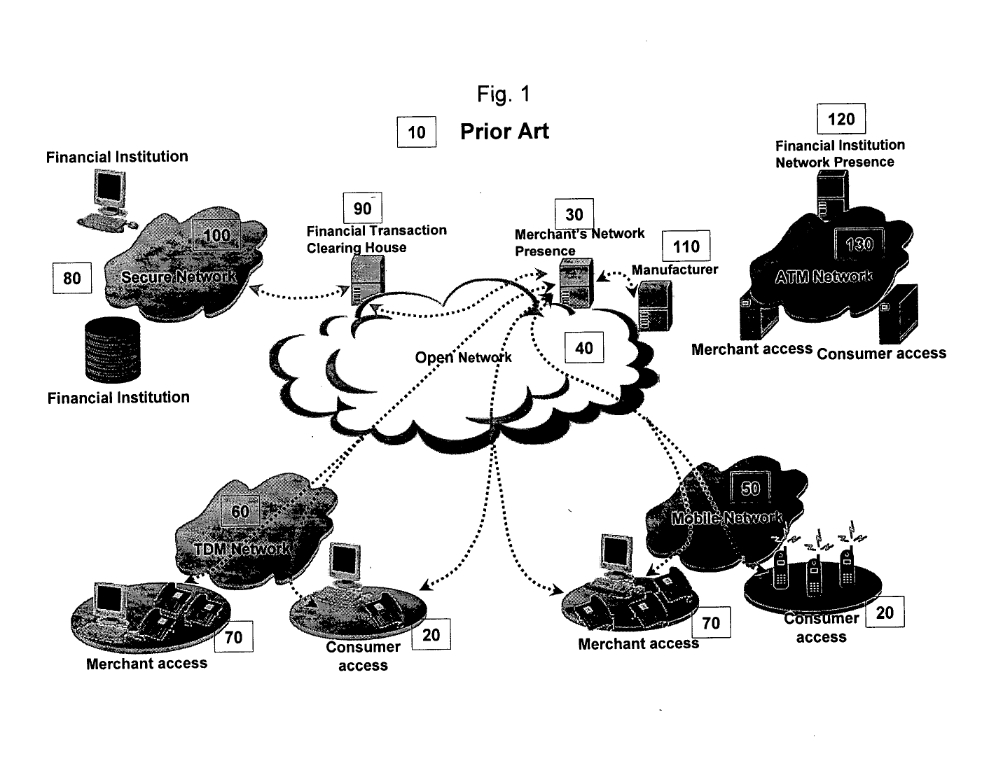

FIG. 2 is a schematic drawing of a distributed network system constructed in accordance with the invention; and

FIG. 3 is a flow chart of the operation of an e-commerce distributed network in accordance with the invention.

### DETAILED DESCRIPTION OF THE INVENTION

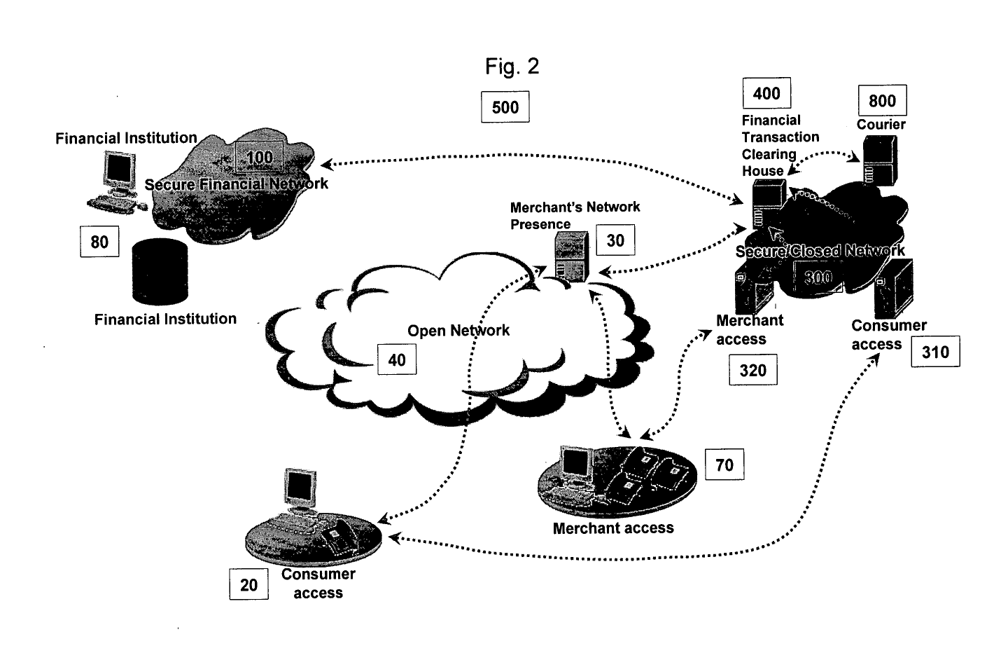

Reference is made to FIG. 2 wherein a secure e-commerce distributed network, generally indicated as system 500, constructed in accordance with the invention is provided. Like numerals are utilized to indicate like structure for ease of description.

System 500 includes an open network 40. A merchant server 30, representing the merchant's presence on open network 40 communicates across open network 40 with consumers at remote computers 20 as is known in the art. Merchants may also access merchant server 30 from remote computer 70.

It should be noted, that computers, when described in the invention, may be any interactive device which allows a user to communicate with a server and receive some type of text, audio, visual or audio/visual content at the computer 20, 70. It should also be noted that the preferred embodiment is an Internet based system; however, the system may include any device capable of allowing interaction with a server and providing information across an open distributed network to a merchant and consumer. The computers may communicate with the servers by Internet, radio frequency, telephone, cable TV, handheld personal data accessory or cellular phone by way of non-limiting examples.

System 500 includes a secure closed network 300. Secure closed network 300 is a high security, well fire-walled secure enclosed network. A merchant portal 320 provides protected merchant access to closed network 300. Similarly, a consumer access portal 310 provides protected consumer access to closed network 300. Access to closed network 300 through either merchant portal 320 or consumer portal 310 requires a password, personal identification number (PIN), biometric or other self-identifying mechanism to prevent inadvertent and unauthorized access to closed network 300. Portals are used by way of example, but any discrete access mechanism to the secured network by merchant and consumer is contemplated, including, but not limited to, by way of contrast, a single access point having separate password protected access for each of merchant and consumer. What is necessary is that merchant and consumer be isolated from each other.

A financial transaction clearing house server 400 forms part of closed network 300. Server 400 communicates with merchant server 30 over open network 40, but is better protected than merchant server 30 by its association with secure/closed network 300 and limited access through open network 40. In a preferred embodiment, financial transaction clearing house server 400 may communicate with merchant network server 30 through protected portal 320, dedicated lines to provide a virtual local access network, make use of firewalls, encryption and password protection to increase the security of information transferred between merchant network server 30 and financial transaction clearing house server 400. However, as will be discussed below, the primary protection is that non-sensitive information is primarily the type of information communicated between financial transaction clearing house server 400 and merchant server 30.

In one preferred embodiment, consumer information such as consumer identification, consumer billing information, including bank accounts, credit card information, financial records or the like dependent upon payment preferences and history, as well as physical address information, are stored within secure network 300 either at the server at portal 310 or server 400. Similarly, sensitive information regarding merchants such as bank account information, payment preferences, physical address and the like or other sensitive business information may be stored in a preferred embodiment on secure/closed network 300 at either merchant portal 320, server 400 or some other database protected within network 300.

System 500 also includes secure financial network 100 operatively provided between remote computers 80 of a financial institution and financial transaction clearing house server 400. Financial transaction clearing house server 400 communicates with financial institution remote computers 80 across secure financial network 100. In this way, communications between financial transaction clearing house server 400 and financial institution server 80 communicate over a secure network and consumers and merchants communicate with financial transaction clearing house over a secured closed network. In contrast, consumers communicate with merchant server 30 over open network 40. In this way, the financial aspects of a purchase are bifurcated from the product selection aspect of the purchase.

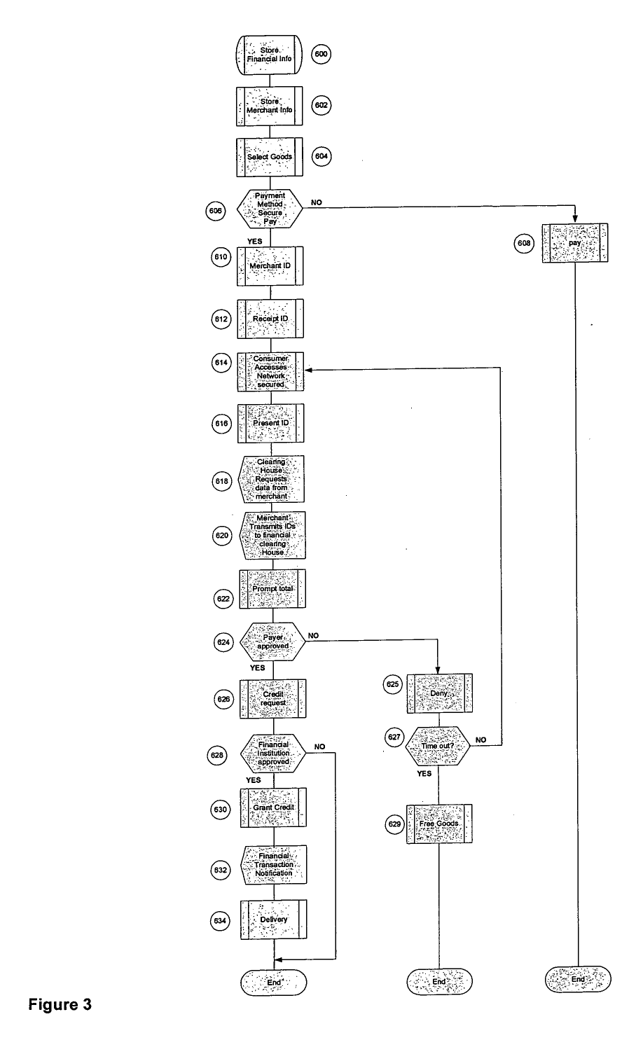

Reference is now made to FIG. 3 in which a flow chart for performance of the method of the invention is provided. In a first step 600, sensitive consumer financial information is stored in secure closed network 300, preferably at financial transaction clearing house server 400. Confidential merchant information may also be stored within secure closed network 300 in a step 602. As discussed above, such information may include credit card information, credit payer preferences, bank account information or the like for the consumer. In one embodiment, it may also include customer shipping information. For the merchant, it may also include bank account information and payment preferences.

Steps 600 and 602 are registrations in nature and occur prior to the e-commerce transaction between consumer 20 and merchant 30. In a step 604, the consumer at their remote computer 20 accesses the merchant's network presence, usually a website hosted at server 30, across open network 40. The consumer will browse the website, select the merchant goods/services and check out at the website. This entire process occurs over open network 40.

During checkout, merchant server 30 will query to the consumer at remote computer 20 regarding the payment method in step 606. The merchant will offer the consumer the option to pay utilizing a secure network in accordance with the invention. If the consumer declines, then consumer pays merchant in accordance with the prior art in a step 608.

If a secure payment process is requested, then merchant server 30 generates a merchant ID in a step 610 which is preassigned to the merchant by the financial transaction clearing house. This ID is merchant specific and stored at server 400. Merchant server 30 then creates a receipt ID, which is transaction specific in a step 612. The receipt ID includes a transaction date/time stamp. The receipt ID, merchant ID and purchase total are forwarded to the consumer at their computer 20.

In a step 614, at a later time, the consumer accesses secured closed network 300 through portal 310. Because it is a secure network, access may be PIN and PIN/Password protected. Access may also be limited to preapproved subscribers stored at a network server within closed network 300 to further limit access.

Once access is granted, the consumer will input the merchant ID and receipt ID to server 400 in a step 616. In response to the presentation of the ID information by the consumer, server 400 requests receipt information corresponding to ID information presented by the consumer. Merchant server 30 in a step 618 forwards the receipt information, including the dollar amount representing the transaction amount due corresponding to clearing house server 400 across open network 40 in a step 620. Clearing house server 400 provides the transaction total to the consumer at computer 20.

In a step 622, the consumer gives its approval to the total if it matches the expected sum. There are two reasons why approval would not be given. First, tampering with the information at the merchant end so the true consumer would not accept an altered transaction, or an imposter who somehow has obtained the receipt ID and/or merchant ID attempting to execute the transaction and mistakenly denies the amount due. If approval is not given, the processing of the transaction is denied in a step 625. However, the goods are still reserved for the transaction. In order to allow the true consumer to purchase the good, a time limit is provided during which the consumer needs to approve the transaction in a step 627. If the time limit expires, then the goods are freed for resale in a step 629. If the time limit has not expired, the process returns to step 614 to await consumer access of the network to repeat steps 614-622.

If approval is given, then financial transaction clearing house server 400 communicates with the financial institution, identified by the prestored consumer information, across secure financial network 100 to request a credit for the receipt total in a step 626. This credit may be by way of credit card, credit line, automatic withdrawal or any similar arrangement instructions which are stored in secure network 300 and/or secure financial network 100.

If the financial institution approves the transaction, i.e., sufficient credit is available on behalf of the consumer, in a step 628, the financial institution through its servers/computers 80, notifies the financial transaction clearing house that a transfer of funds is being or will be made in a step 630. Financial transaction clearing house server 400 then causes the transfer of funds to merchant's financial institution across a secure network. In a step 632, the merchant and consumer are immediately sent confirmation of the completion of the financial transaction through secure/closed network 300. The merchant server 30 is also sent immediate confirmation by clearing house server 400 via open network 40. The goods are then delivered in accordance with the prior art.

The merchant now arranges for delivery of the goods in accordance with the consumer's instructions as is known in the art. This may be based upon delivery instructions provided either at the time of the product selection or as prestored instructions.

It should also be noted, that by date stamping the product, server 400 may, in accordance with transaction instructions, allow a transaction to expire. In other words, by way of non-limiting example, a purchaser is given 48 hours during which to complete the financial portion of the transaction. In this way, consumers cannot “hold” stock indefinitely which would put merchants at a significant disadvantage.

For ease of description, the consumer performs the entire transaction utilizing its remote computer 20. However, it should be noted, that the payer, i.e., the entity arranging for payment, need not be the consumer or the person who selects the product for purchase. It can be any payee to whom consumer has given the ID information and who has stored their payment information on secure network 300. It should be noted, by providing a separate secured network for the financial aspect of the transaction, goods may be purchased over an open network, whilst the sensitive financial information is handled in a secure manner.

It should also be noted that financial institution server 80 and financial transaction clearing house server 400 are shown as distinct servers to acknowledge the fact that financial clearing house server 400 may need to interact with multiple financial institutions as a function of customer and merchant information. However, in a contemplated embodiment, the clearing house may be the merchant's or consumer' financial institution consolidating functionality. Additionally, there may be in fact several closed networks 300 to accommodate a plurality and variety of merchants and customers.

In a further embodiment, Internet adverse consumers will not even provide their physical address or any information across an open network. In this instance, delivery step 634 is altered. In step 632, once merchant and consumer are sent confirmation of the completion of the financial transaction, server 400 instructs merchant server 30 over secure closed network 300 to arrange for shipment of the product to an identified courier (at a courier server 800) along with the merchant ID and receipt ID corresponding to that transaction. Financial transaction clearing house server 400 or such other server located at secure closed network 300 forwards the consumer delivery address, merchant ID and receipt ID to courier server 800, preferably over secure closed network 300. The courier matches the product with the pertinent ID information with the delivery instruction with the pertinent ID information and makes the delivery. In this way, there is no communication of even the physical address or delivery instructions across open network 40.

It would be appreciated by persons skilled in the art that the present invention is not limited to what has been particularly described hereinabove. In addition, unless mention was made above to the contrary, it should be noted that all the accompanying drawings are not to scale. A variety of modifications and variations are possible in light of the above teachings without departing from the spirit and scope of the invention, which is limited only by the following claims.

What is claimed as new and desired to be protected by Letters Patent of the United States is:

1. A system for conducting commerce across a distributed network comprising:
a remote consumer computer;
a merchant server communicating with said remote consumer computer across an open network to enable a purchase of a product from said remote consumer computer;
a financial clearing house server located within a secured closed network and communicating with said remote consumer computer and said merchant server across said secured closed network;
said merchant server creating a merchant ID, receipt ID and transaction total corresponding to the purchase and sending the merchant ID, receipt ID, and transaction total to said financial clearing house server and said remote consumer computer; and
said financial clearing house server arranging payment of the purchase in response to a matching merchant ID, receipt ID, and transaction total from said remote consumer computer.

2. The system of claim 1, further comprising a financial institution computer located within a secure financial network and communicating with said financial clearing house server across said secure financial network, said financial clearing house server arranging for payment by requesting credit approval from said financial institution and arranging for transfer of credit by at least one of credit and funds to said merchant server in response to a granting of credit by said financial institution.

3. The system of claim 1, wherein said merchant server sends the receipt ID and transaction total to the financial clearing house server in response to a request from said financial clearing house server.

4. The system of claim 1, wherein financial information about said consumer is stored at said financial clearing house server.

5. The system of claim 1, wherein said financial information includes consumer billing information.

6. The system of claim 4, wherein said financial information includes consumer payment preferences.

7. The system of claim 4, wherein said financial information includes one of consumer bank and credit card information.

8. The system of claim 1, further comprising a courier server communicating with said merchant server across said open network, and communicating with said financial transaction clearing house server across a secure network, said courier server receiving said merchant ID and receipt ID from said merchant server and said financial transaction clearing house server, and arranging for shipment of a purchased product in accordance with shipping instructions.

9. A method for conducting commerce across a distributed network, the distributed network having a remote consumer computer, a merchant server, and a financial clearing house server, the method comprising the steps of:
a consumer, selecting a product for purchase by communicating by the remote consumer computer with the merchant server across an open network;
upon completion of the purchase, the merchant server creating a merchant ID, a receipt ID, and a transaction total and communicating the merchant ID, receipt ID and transaction total corresponding to the purchase to said remote consumer computer across an open network;
said customer, communicating said merchant ID and receipt ID and transaction total to a financial clearing house server across a secure network;
said financial clearing house server requesting said receipt ID and transaction total from said merchant server across said secure network; and
said financial clearing house server arranging for payment for said purchase in response to a match between said merchant ID, receipt ID and transaction total from said remote consumer computer and said merchant server.

10. The method of claim 9, further comprising the steps of storing financial information about the consumer within the secure network.

11. The method of claim 9, further comprising the step of storing merchant financial information in the secure network.

12. The method of claim 9, wherein financial information about said consumer is stored at said financial clearing house server.

13. The method of claim 12, wherein said financial information includes consumer billing information.

14. The method of claim 13, wherein said financial information includes consumer payment preferences.

15. The method of claim 13, wherein said financial information includes one of consumer bank and credit card information.

16. The method of claim 9, further comprising providing a courier server; upon arranging for payment for said purchase, said financial clearing house server sending said merchant ID, receipt ID and transaction total to said courier; said merchant server sending said merchant ID, receipt ID to said courier, said courier arranging shipment to said consumer in response to a match between said merchant ID and receipt ID received from said merchant server and financial transaction clearing house server.

17. The method of claim 16, wherein said financial transaction clearing house server communicates with said courier server over a second secure network.

18. The method of claim 9, wherein said financial transaction clearing house server arranges for payment by requesting credit on behalf of a consumer from a financial institution across a secure financial network.
